(19) United States
(12) Patent Application Publication
(10) Pub. No.: US 2024/0166857 A1
(43) Pub. Date: May 23, 2024

(54) HALOGEN-FREE RUBBER COMPOSITIONS AND MEMBRANES

(71) Applicant: CARLISLE CONSTRUCTION MATERIALS, LLC, Carlisle, PA (US)

(72) Inventors: Majid KARIMI NEJAD, Carlisle, PA (US); Anil SHENOY, Mechanicsburg, PA (US)

(73) Assignee: CARLISLE CONSTRUCTION MATERIALS, LLC, Carlisle, PA (US)

(21) Appl. No.: 17/989,502

(22) Filed: Nov. 17, 2022

(51) Int. Cl. C08L 23/16; C08K 3/22; C08K 5/521; C08L 39/04

(52) U.S. Cl. CPC C08L 23/16; C08K 3/22; C08K 5/521; C08L 39/04; C08K 2003/2224; C08K 2003/2227; C08L 2201/02; C08L 2201/22

(57) ABSTRACT

The disclosure herein relates to EPDM rubber compositions and membranes. More specifically, the present disclosure relates to halogen-free, fire-resistant EPDM rubber compositions and membranes, and to methods of making them. In one embodiment, the halogen-free EPDM rubber membrane is used for weatherproofing buildings, in particular as a membrane for façade application.

### FIELD OF THE INVENTION

The disclosure herein relates to EPDM rubber compositions and membranes. More specifically, the present disclosure relates to halogen-free, fire-resistant EPDM rubber compositions and membranes, and to methods of making them. In one embodiment, the halogen-free EPDM rubber membrane is used for weatherproofing buildings, in particular as a membrane for façade application.

### BACKGROUND

Ethylene propylene diene monomer (EPDM) rubber has many remarkable properties such as heat resistance, chemical resistance, low electrical conductivity, stability at temperatures ranging from −50° F. to +350° F., flexibility at low temperatures, and weather resistance to name a few. EPDM is cost effective and can be fabricated in a variety of ways including custom molding and extruded parts. EPDM has numerous applications in the automotive industry (e.g., hoses, seals, O-rings, gaskets, accumulator bladders, wire and cable connectors and insulators, diaphragm, and weather stripping); construction (e.g., roofing and waterproofing); HVAC (e.g., compressor grommets, tubing, gaskets, and seals); and many other industries.

The main drawback to EPDM rubber is its flammability. One approach to improving the flame retardancy of polymers is the through the incorporation of one or more flame retardants into the polymer. Doing so, however, is not a trivial task. Not only is the type of flame retardants important, the loading required to achieve the desired result is crucial. Changes to a polymeric system (by, for example, replacing part of the polymer with one or more additives) will influence its properties and final performance. As a result, the amount of flame retardant should be high enough to ensure required fire-retardant properties, but at the same time should not exceed the maximum load for maintaining desired properties.

Halogenated retardants have been used but are disadvantageous as EPDM rubber treated with halogenated flame retardants generate heavy smoke harmful to health and the environment during burning. Metal hydroxides are widely used as non-halogenated fire retardants in a broad range of applications such as building and construction materials, wire, and cable. Such materials, however, usually impart a poor flow, lower cure state, and deteriorate the physical properties of the rubber to which they are added due to weak filler-polymer interactions. Accordingly, there is a need for improved halogen-free fire-resistant EPDM rubber.

### SUMMARY OF THE INVENTION

In one aspect of the invention, the disclosure herein is directed to a halogen-free fire-resistant EPDM rubber composition that achieves the best balance of fire retardancy, flow, physical properties, and formulation cost. In one embodiment, the fire-resistant EPDM rubber composition comprises ethylene propylene diene monomer (EPDM) polymer, one or more metal hydroxides, and a melamine poly (metal phosphate). The foregoing rubber composition may also include fillers such as kaolin clay, and curing agents such as sulfur or one or more sulfur-releasing compounds. The foregoing rubber composition may also include activators and/or accelerators such as zinc oxide, stearic acid, or combinations thereof. In one embodiment, the halogen-free fire-resistant EPDM rubber composition comprises EPDM polymer, magnesium hydroxide, aluminum hydroxide, and melamine poly (zinc phosphate).

In another aspect of the invention, the disclosure herein is directed to a halogen-free fire-resistant EPDM membrane comprising EPDM, one or more metal hydroxides, and a melamine poly (metal phosphate). The foregoing EPDM membrane may also include fillers such as kaolin clay, and curing agents such as sulfur or one or more sulfur-releasing compounds. The foregoing EPDM membrane may also include activators and/or accelerators such as zinc oxide, stearic acid, or combinations thereof. In one embodiment, the halogen-free fire-resistant EPDM membrane comprises EPDM, magnesium hydroxide, aluminum hydroxide, and melamine poly (zinc phosphate).

In another aspect of the invention, the disclosure herein is directed to methods for making a halogen-free fire-resistant EPDM membrane comprising the steps of: making a homogeneous mixture of EPDM, one or more metal hydroxides, and a melamine poly (metal phosphate); processing the mixture into a membrane using either calendering or a roller die extruder; and curing the membrane with heat.

### DETAILED DESCRIPTION

### EPDM Rubber Composition

Ethylene propylene diene monomer (EPDM) rubber is a synthetic rubber compound made from ethylene, propylene, and a diene co-monomer that can be crosslinked via sulfur vulcanization. Dienes used in the manufacture of EPDM rubbers are ethylidene norbornene (ENB), dicyclopentadiene (DCPD), and vinyl norbornene (VNB). In one embodiment of the present invention, the EPDM component of the rubber composition comprises about 1-12% ENB and has a Mooney viscosity (ML 1+4 at 125° C.) of about 20-100 and a Mooney-Rivlin constant (C2) of about 50-85. In one embodiment, the rubber composition comprises EPDM monomer combined with carbon black, other fillers, process oil, stearic acid, and zinc oxide.

Carbon black serves as a colorant and as a reinforcing filler for the rubber composition. In one embodiment, the carbon black comprises one or more furnace blacks including general-purpose furnace, fast-extrusion furnace, or semi-reinforcing furnace. In one embodiment, the carbon black component comprises from about 40 to about 140 parts per hundred rubber (phr).

Other fillers provide additional reinforcement to the rubber composition and to sheeting made from such compositions. Fillers may comprise talc, kaolin clays, chemically modified clays, hard clays, water-washed clays, soft clays, calcined clays, calcium carbonate, mica, and/or silica. In one embodiment, fillers comprise from about 20 to about 120 phr.

Processing aids reduce viscosity and improve processability of the rubber composition. Non-limiting examples of processing aids include hydrocarbon resins; fatty acids soaps; fatty acid esters; paraffins; polyethylene waxes; EVA waxes; phenolic resins; petroleum derived oils; and polyethylene acrylic acid. In one embodiment, the processing aid is paraffinic oil. In another embodiment, the processing aid is essentially free of aromaticity. In another embodiment, the processing aid is naphthenic oil. When used, the amount of processing oil can range from about 20 to about 120 phr, or from about 30 to about 100 phr.

Zinc oxide acts as an activator in the vulcanization process, adds strength to rubber composition, improves resistance against heat/abrasion, and helps guard against ultraviolet degradation. In one embodiment, zinc oxide comprises from about 1.5 to about 10 phr.

Stearic acid improves the dispersion of the zinc oxide and increases cross-linking density in the vulcanization process. In one embodiment, the stearic acid component comprises from about 0.5 to about 2.5 phr.

Other materials that can be added to the rubber compositions include processing aids and antioxidants. These materials are used to improve rubber flow and heat resistance. In one embodiment, these other materials comprise from about 0 to about 20 phr.

Metal hydroxides provide fire resistance to the rubber compositions and to rubber membranes made therefrom. Suitable metal hydroxides include aluminum hydroxide and magnesium hydroxide, and may comprise coated or uncoated powders have an average particle side from about 0.5 to about 5 microns. In one embodiment, the aluminum hydroxide and magnesium hydroxide components each comprise up to about 100 phr. In another embodiment, the aluminum hydroxide and magnesium hydroxide components each comprise from about 10 to about 100 phr. In another embodiment, the aluminum hydroxide and magnesium hydroxide components each comprise from about 10 to about 20 phr.

Melamine poly(metal phosphates) further contribute to the fire resistance of the rubber compositions and to rubber membranes made therefrom. Suitable melamine poly(metal phosphates) include melamine poly(aluminum phosphate), melamine poly(zinc phosphate), and melamine poly(magnesium phosphate). In one embodiment, the melamine poly(metal phosphate) comprises up to about 50 phr. In another embodiment, the melamine poly(metal phosphate) comprises from about 5 to about 50 phr. In another embodiment, the melamine poly(metal phosphate) comprises from about 5 to about 10 phr.

Sulfur and cure packages facilitate cross-linking reactions when the rubber composition is cured. Non-limiting examples of accelerators include ethylene thiourea, N,N′-dibutylthiourea, N,N′-diethylthiourea, thiuram monosulfides and disulfides such as tetramethylthiuram monosulfide (TMTMS), tetrabutylthiuram disulfide (TBTDS), tetramethylthiuram disulfide (TMTDS), tetraethylthiuram monosulfide (TETMS), dipentamethylenethiuram hexasulfide (DPTH). Accelerators may also comprise N,N′-di-(2-methylphenyl)-guanadine, 2-mercaptobenzothiazole, 2-(morpholinodithio)-benzothiazole, zinc 2-mercaptobenzothiazole, and dithiocarbamates such as tellurium diethyldithiocarbamate, copper dimethyldithiocarbamate, bismuth dimethyl dithiocarbamate, cadmium diethyldithiocarbamate, lead dimethyldithiocarbamate, zinc diethyldithiocarbamate, zinc dimethyldithiocarbamate, and zinc dibutyldithiocarbamate (ZDBDC). Accelerators may also comprise benzothiazole sulfenamides such as N-oxydiethylene-2-benzothiazole sulfenamide, N-cyclohexyl-2-benzothiazole sulfenamide, N,N′-diisopropyl-2-benzothiazole sulfenamide, N-tert-butyl-2-benzothiazole sulfenamide (TBBS), and other thiazole accelerators such as 2-mercaptobenzothiazole (MBT), benothiazole disulfide (MBTS), 2-mercaptoimidazoline, and N,N′-diphenylguanadine. In one embodiment, sulfur comprises from about 0.3 to about 3 phr and the cure package comprises from about 0.4 to about 10 phr.

### EPDM Membrane

In another aspect of the invention, the disclosure herein is directed to a halogen-free fire-resistant EPDM membrane comprising EPDM, one or more metal hydroxides, and a melamine poly (metal phosphate). The EPDM membrane may also include fillers such as kaolin clay. The foregoing EPDM membrane may also include curing agents such as sulfur or one or more sulfur-releasing compounds. The foregoing EPDM membrane may also include activators and/or accelerators such as zinc oxide, stearic acid, or combinations thereof. In one embodiment, the halogen-free fire-resistant EPDM membrane comprises EPDM, up to 100 phr magnesium hydroxide, up to 100 phr aluminum hydroxide, and up to 50 phr melamine poly (zinc phosphate).

### Methods

Making the halogen-free, fire-resistant EPDM rubber membranes of the present invention generally involves three steps: mixing, processing, and curing. During the mixing step, EPDM monomer, one or more metal hydroxides, and a melamine poly (metal phosphate) are formed into a homogenous mixture using a high-shear mixing machine such as an internal mixer, extruder, a two-roll mill, or other mixers suitable for forming viscous, relatively uniform mixtures. Non-limiting examples of mixers include Banbury mixers, which are internal mixers or mills or extruders.

In one embodiment, the ingredients can be added together at once. In another embodiment, dry ingredients such as mineral fillers, zinc oxide, stearic acid, and anti-UV and anti-aging materials are added first, followed by the liquid process oil, and finally the EPDM (this type of mixing can be referred to as an upside-down mixing technique). The resultant mixture forms a master batch to which the cure package can then be added. Two-stage mixing can be employed. The sulfur cure package (sulfur/accelerator) can be added near the end of the mixing cycle and at lower temperatures to prevent premature crosslinking of the EPDM. Mixing times generally range from about 2 to about 6 minutes.

During the processing step, the compound is formed into its final shape using molding, calendering, or extruding (e.g., roller dies). In some embodiments, the resulting admixture can be sheeted to a various thickness by conventional sheeting methods, for example, milling, calendering, or extrusion.

Curing can be done using various methods including using a curative or cure system (including those disclosed in US Publ. No. 2021/0403693, incorporated herein by reference), heating (with or without pressure), and radiation (with or without pressure). In some embodiments, the molded compound can be cured in an autoclave or other rubber curing equipment such as compression molding. In some embodiments, curing is accomplished by hot air-UHF, LCM, and autoclave at a specific temperature, generally between about 135° C. to about 180° C. or between about 135° C. to about 165° C. The cure time may be between about 2 minutes to about 9 hours depending upon the cure temperature. Once cured, the compound can be cut or trimmed to the desired dimensions.

### Examples

In preparing samples of both halogenated and non-halogenated fire-resistant EPDM rubber compositions, a master batch EPDM rubber formulation as shown in Table 1 was used.

TABLE 1

| Ingredients | EPDM Rubber Formulation (phr) |
|---|---|
| EPDM monomer | 100 |
| Carbon black | 80 |
| Clay | 38 |
| Process oil | 55 |
| Stearic acid | 1 |
| Zinc oxide | 3 |
| Struktol ® A60 | 3 |

Using the EPDM rubber formulation of Table 1, samples of halogenated and non-halogenated fire-resistant EPDM rubber compositions as shown in Table 2 were prepared.

TABLE 2

| | (phr) | | |
|---|---|---|---|
| Ingredients | Control 1 | Control 2 | Trial |
| Carbon black filled EPDM of Table 1 | 280 | 280 | 280 |
| Magnesium hydroxide | 25 | 25 | 25 |
| Decabromodiphenyl ether + antimony | 21 | | |
| oxide | | | |
| Aluminum hydroxide | | 21 | 14 |
| Melamine poly (zinc phosphate) | | | 7 |
| Sulfur | 1 | 1 | 1 |
| ZDBC | 0.9 | 0.9 | 0.9 |
| TBBS | 0.45 | 0.45 | 0.45 |
| CTP | 0.2 | 0.2 | 0.2 |

The halogenated and non-halogenated fire-resistant EPDM rubber compositions were then milled out and press-cured at 160° C. for 35 minutes. The properties of these press-cured materials were measured according to the parameters shown in Table 3.

TABLE 3

| | Lab scale samples | | |
|---|---|---|---|
| Test description | Control 1 | Control 2 | Trial |
| Mooney viscosity (Mu) | 55 | 50 | 51 |
| Scorch time T10 (min) | 24 | 20 | 18 |
| Tensile strength (psi) | 1781 | 1515 | 1601 |
| 300% modulus (psi) | 593 | 587 | 684 |
| Elongation at break (%) | 703 | 730 | 662 |
| Hardness (Shore A) | 65 | 61 | 62 |
| Max loss weight rate (%/c) | 0.55 | 0.62 | 0.55 |
| Ending time burn (sec) | 528 | 363 | 723 |
| Avg. mass loss rate (gr/m²s) | 4.35 | 4.45 | 4.3 |
| Peak heat release (KW/m²) | 283 | 265 | 263 |
| Intumescent char | No | No | Yes |

These halogenated and non-halogenated fire-resistant EPDM rubber compositions were then extruded into sheets, and the properties of these finished EPDM sheets were measured according to the parameters as shown in Table 4.

TABLE 4

| | | Finished product/Sheet | | |
|---|---|---|---|---|
| Test description | Target | Control 1 | Control 2 | Trial |
| Thickness (mil) | 54-66 | 57 | 58 | 57 |
| Tensile strength (psi) | >1305 | 1388 | 1362 | 1434 |
| 300% modulus (psi) | >400 | 548 | 686 | 501 |
| Elongation at break (%) | >300 | 680 | 588 | 773 |
| Hardness (Shore A) | 40-70 | 61 | 59 | 57 |
| Tear resistance (lbs/in) MD | >150 | 167 | 203 | 206 |
| Tear resistance (lbs/in) CD | >150 | 171 | 206 | 206 |
| UL790/Class A fire resistance | Pass | Pass | Fail | Pass |

The examples set forth above are provided to give those of ordinary skill in the art a complete disclosure and description of how to make and use embodiments of the compositions and are not intended to limit the scope of what the inventors regard as their invention. Modifications of the above-described modes (for carrying out the invention that are obvious to persons of skill in the art) are intended to be within the scope of the following claims. All publications, patents, and patent applications cited in this specification are incorporated herein by reference as if each such publication, patent, or patent application were specifically and individually indicated to be incorporated herein by reference.

What is claimed is:

1. A halogen-free, fire-resistant rubber composition comprising ethylene propylene diene (EPDM), one or more metal hydroxides, and a melamine poly (metal phosphate).

2. The composition of claim 1, wherein the one or more metal hydroxides comprise aluminum hydroxide and magnesium hydroxide.

3. The composition of claim 1, wherein the melamine poly (metal phosphate) comprises melamine poly (zinc phosphate).

4. The composition of claim 1 further comprising one or more fillers.

5. The composition of claim 1 further comprising an accelerator.

6. The composition of claim 5, wherein the accelerator is zinc oxide, stearic acid, or a combination thereof.

7. A halogen-free, fire-resistant rubber membrane comprising EPDM, one or more metal hydroxides, and a melamine poly (metal phosphate).

8. The membrane of claim 7, wherein the one or more metal hydroxides comprise aluminum hydroxide and magnesium hydroxide.

9. The membrane of claim 7, wherein the melamine poly (metal phosphate) comprises melamine poly (zinc phosphate).

10. The membrane of claim 7 further comprising one or more fillers.

11. The membrane of claim 10, wherein the fillers are selected from the group consisting of carbon black, talc, kaolin clay, chemically modified clay, hard clay, water-washed clay, soft clay, calcined clay, calcium carbonate, mica, silica, and combinations thereof.

12. The membrane of claim 7, wherein the membrane has a UL 790 Class A fire resistance rating.

13. A method of making a halogen-free, fire-resistant EPDM membrane comprising the steps of:
blending a homogeneous mixture of EPDM, one or more metal hydroxides, and a melamine poly (metal phosphate);
forming the mixture into a membrane; and
curing the membrane.

14. The method of claim 13, wherein the one or more metal hydroxides comprise aluminum hydroxide and magnesium hydroxide.

15. The method of claim 13, wherein the melamine poly (metal phosphate) comprises melamine poly (zinc phosphate).

16. The method of claim 13, wherein the one or more metal hydroxides comprise aluminum hydroxide and magnesium hydroxide and the melamine poly (metal phosphate) comprises melamine poly (zinc phosphate).

17. The method of claim 13, wherein the homogeneous mixture further comprises one or more fillers.

18. The method of claim 17, wherein the fillers are selected from the group consisting of carbon black, talc, kaolin clay, chemically modified clay, hard clay, water-washed clay, soft clay, calcined clay, calcium carbonate, mica, silica, and combinations thereof.

19. The method of claim 13, wherein the curing step uses sulfur or a sulfur donor compound.

20. The method of claim 13, wherein the membrane has a UL 790 Class A fire resistance rating.
